(19) United States
(12) Patent Application Publication
(10) Pub. No.: US 2014/0258697 A1
(43) Pub. Date: Sep. 11, 2014

(54) Apparatus and Method for Transitive Instruction Scheduling

(71) Applicant: MIPS TECHNOLOGIES, INC., Sunnyvale, CA (US)

(72) Inventors: Ranganathan Sudhakar, Santa Clara, CA (US); Debasish Chandra, Fremont, CA (US); Qian Wang, Santa Clara, CA (US)

(73) Assignee: MIPS TECHNOLOGIES, INC., Sunnyvale, CA (US)

(21) Appl. No.: 13/789,427

(22) Filed: Mar. 7, 2013

(51) Int. Cl. G06F 9/30

(52) U.S. Cl. CPC G06F 9/30079
USPC 712/245

(57) ABSTRACT

A processor includes a multiple stage pipeline with a scheduler with a wakeup block and select logic. The wakeup block is configured to wake, in a first cycle, all instructions dependent upon a first selected instruction to form a wake instruction set. In a second cycle, the wakeup block wakes instructions dependent upon the wake instruction set to augment the wake instruction set. The select logic selects instructions from the wake instruction set based upon program order.

### FIELD OF THE INVENTION

This invention relates generally to microprocessors. More particularly, this invention relates to instruction scheduling in out-of-order microprocessors.

### BACKGROUND OF THE INVENTION

Out-of-order microprocessors employ dynamic scheduling to achieve high instruction throughput. Unlike many other microarchitectural components, schedulers cannot be pipelined to obtain higher frequency without losing a corresponding factor in instruction throughput. Thus, the fundamentally “atomic” nature of the scheduling operation limits the minimum clock cycle duration that can be achieved.

Dynamic schedulers employ a variety of techniques but all known methods are based on two cyclically interdependent phases of operation, usually known as Wakeup and Pick. As a result, the frequency of operation is limited by the latency of the Wakeup logic added to the latency of the Pick logic. These latencies increase as the size of the scheduler increases, making it difficult to build a large, yet fast scheduler.

To improve frequency, a scheduler can employ multiple hot tags for Wakeup and Pick, where each bit in a “picked” bit-vector represents a dependency on one entry in the scheduler. Such decoded-tag schedulers are faster than conventional encoded-tag schedulers at the cost of area but are still limited by the fundamentally additive delays in the alternation of (Wakeup→Pick)→(Wakeup→Pick)→ . . . This means that there are critical paths from Wakeup to Pick and also from Pick to Wakeup. Thus, such a loop cannot be pipelined to obtain faster cycle times without reducing scheduling throughput by an inverse factor, which means that net performance cannot be easily improved by pipelining.

Therefore, it would be desirable to develop improved instruction scheduling techniques. More particularly, it would be desirable to develop an instruction scheduling technique that decouples Wakeup and Pick operations.

### SUMMARY OF THE INVENTION

A processor includes a multiple stage pipeline with a scheduler with a wakeup block and select logic. The wakeup block is configured to wake, in a first cycle, all instructions dependent upon a first selected instruction to form a wake instruction set. In a second cycle, the wakeup block wakes instructions dependent upon the wake instruction set to augment the wake instruction set. The select logic selects instructions from the wake instruction set based upon program order.

A non-transitory computer readable storage medium includes executable instructions to define a processor configured with a multiple stage pipeline including a scheduler with a wakeup block and select logic. The wakeup block is configured to wake, in a first cycle, all instructions dependent upon a first selected instruction to form a wake instruction set. In a second cycle, the wakeup block wakes instructions dependent upon the wake instruction set to augment the wake instruction set. The select logic selects instructions from the wake instruction set based upon program order.

A method includes waking, in a first cycle, all instructions dependent upon a first selected instruction to form a wake instruction set. In a second cycle, instructions dependent upon the wake instruction set are waked to augment the wake instruction set. Instructions are selected from the wake instruction set based upon program order.

### BRIEF DESCRIPTION OF THE FIGURES

The invention is more fully appreciated in connection with the following detailed description taken in conjunction with the accompanying drawings, in which:

FIG. 1 illustrates a microprocessor pipeline that may be used in accordance with an embodiment of the invention.

FIG. 2 illustrates a microprocessor pipeline scheduler that may be used in accordance with an embodiment of the invention.

FIG. 3 illustrates an exemplary instruction sequence processed in accordance with an embodiment of the invention.

FIG. 4 illustrates an instruction dependency vector corresponding to the example of FIG. 3.

FIG. 5 illustrates an instruction picked vector utilized in accordance with an embodiment of the invention.

FIG. 6 illustrates processing operations for the exemplary instruction sequence of FIG. 3.

FIG. 7 illustrates processing operations associated with an embodiment of the invention.

Like reference numerals refer to corresponding parts throughout the several views of the drawings.

### DETAILED DESCRIPTION OF THE INVENTION

The invention is a scheduler that is capable of operating as a sequence of dependent (Wakeup)→(Wakeup)→(Wakeup)→ . . . operations. The Pick logic is moved off the critical path but still acts every cycle so that instruction throughput is not reduced even as cycle time is improved, resulting in higher overall performance.

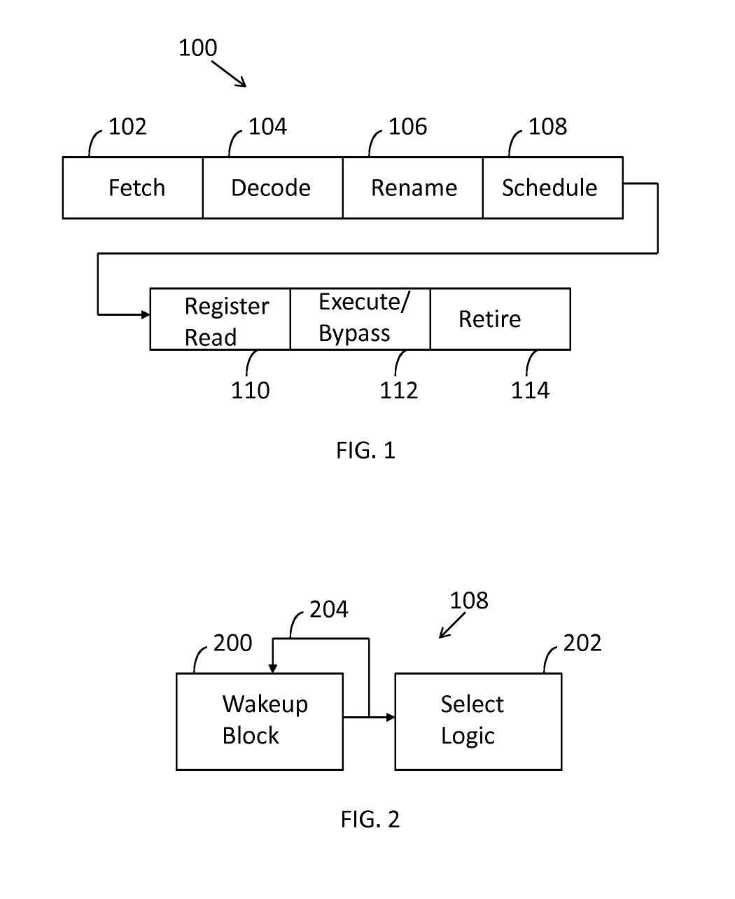

FIG. 1 illustrates an example of a pipeline 100 for a superscalar out-of-order microprocessor that may be used in accordance with an embodiment of the invention. The pipeline 100 includes a fetch stage 102 to fetch instructions, which are then decoded in a decode stage 104. The rename stage 106 converts logical register names to physical register names. The rename stage 106 ensures that all write-after-write and write-after-read hazards are eliminated, leaving only true read-after-write dependencies in the renamed instruction stream. This stream is thus a directed acyclic graph from which operations must be scheduled in dataflow order but not necessarily in program order.

The schedule stage 108 schedules instructions. Usually, there are various dataflow orders that can be chosen for a given instruction stream and a scheduler is free to issue operations in any order as long as the dataflow is not violated. Many schedulers choose to issue operations in program-order, hereinafter referred to as age-priority order. Such a scheduling policy has been shown to be generally optimal for instruction throughput and is provably free of starvation, ensuring forward progress even in multi-threaded machines.

A register read stage 110 accesses registers associated with a selected instruction. The instruction is executed at an execute stage 112 (or it is alternately bypassed). A retire stage 114 retires an executed instruction.

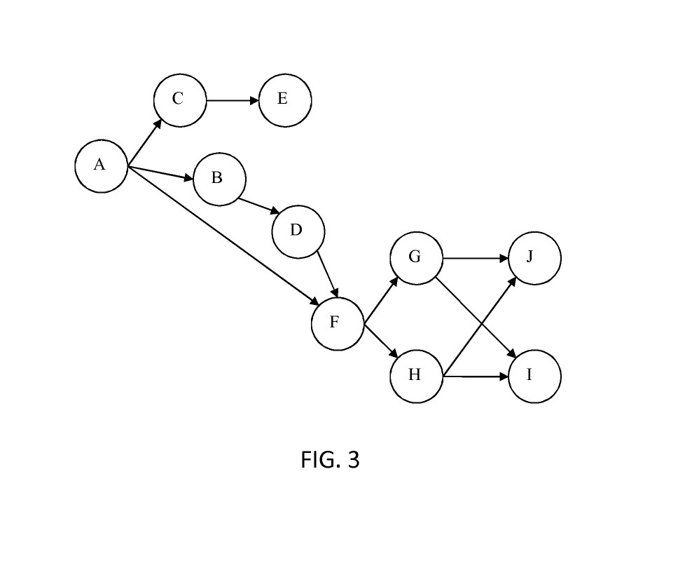

The invention is directed toward the schedule stage 108. FIG. 2 illustrates an example of a schedule stage 108 comprising a wakeup block 200 and select logic 202. The wakeup block 200 utilizes an instruction dependency vector and an instruction picked vector to wake instructions, as discussed below. The wakeup block 200 has a feedback path 204 wherein each instruction that is awake, but not selected (the instruction wake set), is returned to the wakeup block 200. Thereafter, the wakeup block wakes all instructions dependent upon the instruction wake set. This results in accelerated wake operations, as discussed below. The select logic 202 implements program order priority scheduling to pick instructions for execution, as discussed below.

The operations of the invention are more fully appreciated in connection with an example. Consider a case with a program order of: A, B, C, D, E, F, G, H, I, J and with a dependency structure as shown in FIG. 3. This results in a dependency vector as shown in FIG. 4. The far left column simply lists the different instructions in the program, i.e., A, B, C . . . . The top row specifies dependent instructions for instructions in the far left column. If a bit in the mask is set to a digital one, then a dependency exists. So, for example, instruction A is the first instruction in the program and therefore it has no dependencies. Accordingly, the row associated with instruction A only has zero entries. Instruction B is dependent upon instruction A, therefore the second row in FIG. 4 has the first bit set to one to reflect this dependency. The same dependency exists for instructions C and F. Therefore, the vector for rows C and F is the same as the vector for row B. Instructions I and J have dual dependencies on instructions G and H. Consequently, two bits are set in row I and in row J.

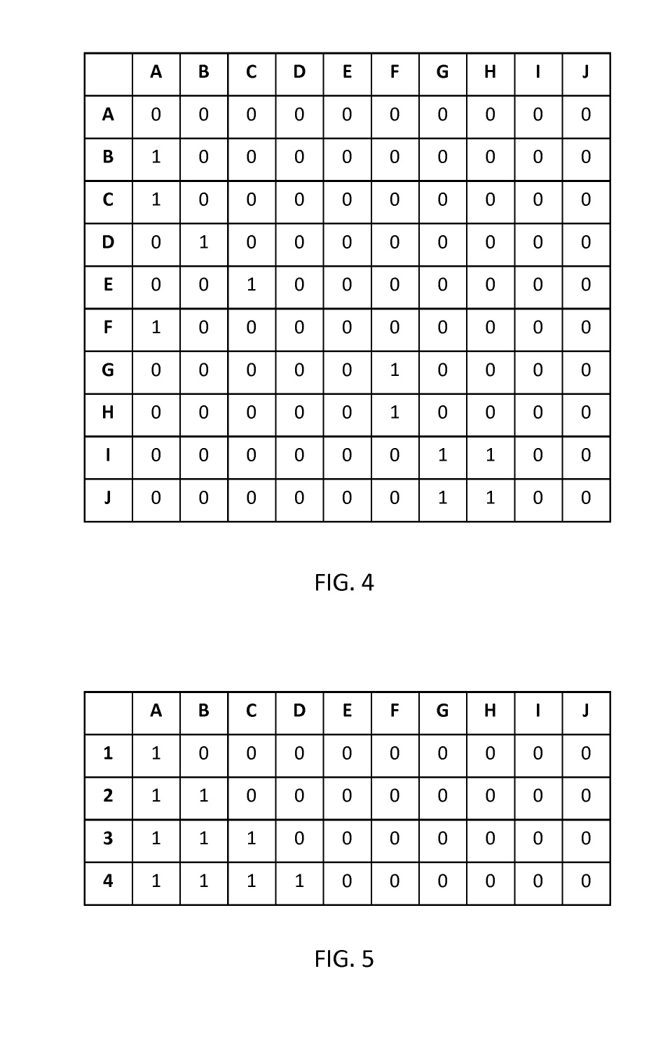

FIG. 5 illustrates an instruction picked vector associated with the current example. The far left column specifies a cycle number while the top row specifies an instruction. Once an instruction is executed, its vector value is set to a digital one. In this example, instruction A is executed in the first cycle so its bit is set to one. In the second cycle, instruction B is executed so the bits for both instruction A and instruction B are set in the second row. Next, instruction C is executed so the bits for Instructions A, B and C are set in the third row. This pattern is repeated to populate an entire instruction picked vector.

For each cycle, a row of the instruction picked vector can be compared with the dependency vector. Simple AND logic can be used to wake an instruction if both a bit in the instruction picked vector and in the dependency vector are set. That is, if an instruction is picked and it has dependent instructions, then those dependent instructions are waked.

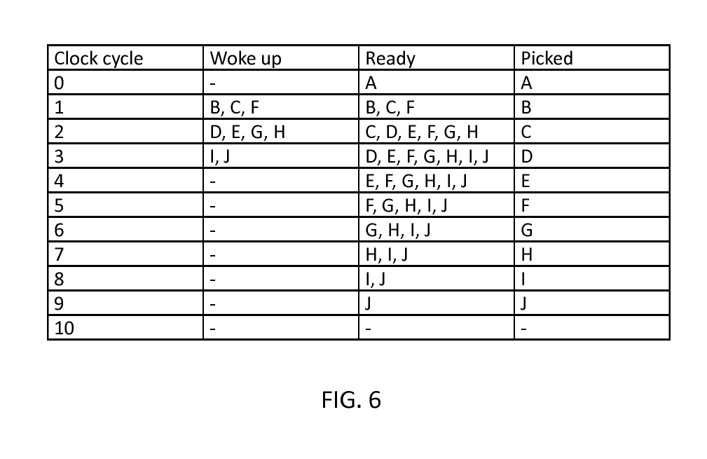

The complete processing associated with this example is shown in FIG. 6. Initially, instruction A is picked as the first instruction in the program. Thus, the bit in the instruction picked vector associated with instruction A is set in FIG. 5. That bit is compared to the A column of the dependency vector of FIG. 4. The A column indicates a dependency for instructions B, C and F. Thus, those instructions satisfy a logical AND condition and wake up, as shown in FIG. 6. Next, instruction B is picked. The instruction picked vector of FIG. 5 has a second row with digital ones associated with the A instruction and the B instruction. The instruction dependency vector is used to identify instructions that are dependent upon instructions that have awaked. Instructions B, C and F awaked in the last cycle. The instruction dependency vector of FIG. 4 illustrates that instruction D is dependent upon instruction B, instruction E is dependent upon instruction C and instructions G and H are dependent upon instruction F. Thus, D, E, G and H awake in the second cycle, as shown in FIG. 6.

FIG. 6 also illustrates that instruction C is picked next. Thus, the third row of the instruction picked vector of FIG. 5 sets the bit for the C instruction. The instruction dependency vector of FIG. 4 is used to identify instructions that are dependent upon instructions that have awaked in the last cycle. In this example, instructions D, E, G and H awoke in the last cycle. The instruction dependency vector of FIG. 4 indicates that instructions D and E do not have any dependencies that need to wake. On the other hand, instructions G and H have instructions I and J as dependent instructions. Thus, I and J awake. As shown in FIG. 6, at this point, all instructions are now ready. Instructions can now be executed based upon age priority.

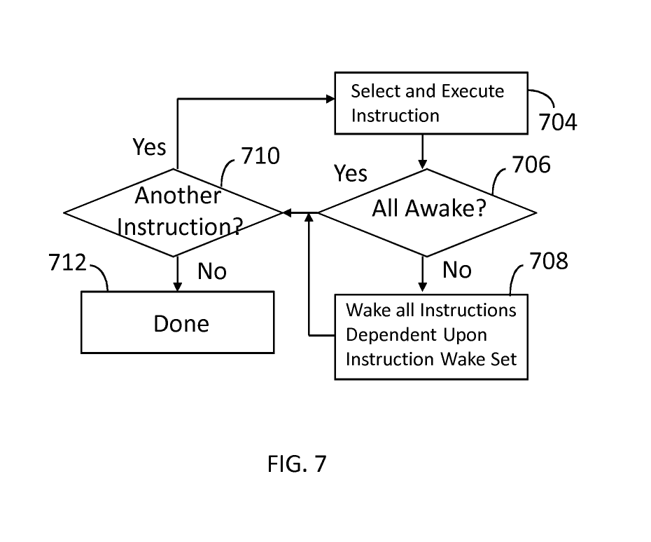

The foregoing processing is characterized in the flow chart of FIG. 7. Initially, an instruction is selected and executed 704. In block 706 it is determined whether all instructions are awake. If not, as is the case here, all dependent instructions are waked to form an instruction wake set 708. For example, clock cycle 1 of FIG. 6 shows instructions B, C and F awake in response to the selection and execution of instruction A.

Processing then proceeds to block 710. Since there are more instructions (710—Yes), processing returns to block 704. In the example of FIG. 6, instruction B is selected and executed. A check can then be made to determine if all instructions are awoken 706. In this iteration the answer is no so all instructions dependent upon the instruction wake set are awoken 708. As shown in FIG. 6, this results in instructions D, E, G and H being awoken.

Control proceeds to block 710 to determine if other instructions need to be executed. At this point, instructions C, D, E, F, G and H are ready for execution. Therefore, control proceeds to block 704 where instruction C is selected and executed. Once again a determination is made if all instructions are awoken 706. In this iteration, there are still instructions to awake. Therefore, control proceeds to block 708, which results in instructions I and J being awoken. Control returns to block 710. Since instructions D, E, F, G, H, I and J are ready, control proceeds to block 704, which results in instruction D being selected and executed. Since all instructions are awake at this point (706—Yes), control proceeds to block 710. More instructions are ready so control loops between blocks 704, 706 and 710 until all instructions are executed, at which point processing is completed 712.

Thus, the invention employs a canonical age-priority scheduler with an issue queue containing a plurality of renamed instructions, from which operations are selected for issue. Assume that there is only one execution pipe to which operations can be issued. This is another necessary condition for functional correctness, which cannot always be provided, based on other factors influencing the scheduler design.

Every cycle, the scheduler picks one operation from the set of eligible operations in the issue queue. The picked operation is issued to an execution pipe and simultaneously broadcasts its identifying information to all the other instructions in the scheduler. The other instructions check if they were dependent on the issuing instruction and if so, record the corresponding input dependency as having matched. When all input dependencies have been matched, the operation is said to be ready. An operation is said to be eligible if it is ready and will not encounter any structural hazard if issued. An operation becomes ready when the latest of its input dependencies is satisfied, i.e., after the last of its producer instructions has issued, which is known as the Wakeup phase. Every cycle, multiple operations Wakeup, so there is a set of eligible operations in the scheduler. Every cycle, the scheduler applies age-priority policy to pick the oldest eligible operation, which is known as the Pick phase. This loop repeats ad infinitum.

As a result, the scheduler operates in a Wakeup→Pick loop as the fundamental loop of recurrence. The delay of the Wakeup and Pick phases can be several logic gates deep and is extremely difficult to fit into a single clock cycle on modern pipeline designs. As a result, this critical path is usually one of the top paths on the core with any reasonable number of scheduler entries. Pipelining the Wakeup→Pick loop so that each phase takes one clock cycle has the extremely undesirable effect of allowing only 1 operation to be picked every other clock cycle or increasing the latency of all single-cycle operations to 2 cycles, both of which have deleterious effects on performance.

In a decoded-tag scheduler, the dependencies passed from Pick to Wakeup are recorded as an N-bit vector, where N is the number of entries in the scheduler. A bit is set in this vector for the operation that was issued at the end of the Pick phase. This instruction picked vector (FIG. 5) is then presented to all scheduler entries at the beginning of the Wakeup phase. Each instruction has already recorded its input dependencies as a per-entry N-bit vector with a bit set in every position that the instruction has a dependency on (FIG. 4). Thus, in the Wakeup phase, each entry compares the Picked vector to its local dependency vector and if it is the last input dependency, the entry declares itself ready, i.e., woken up.

In such a scheduler, it is possible for the instruction picked vector to convey information about multiple producer operations being picked in the same cycle by simply setting appropriate bits in the instruction picked vector. This would typically happen when there are multiple execution pipes, which is not the case in this canonical example. Thus, when one operation is picked in a normal scheduler, one wakes up all its first-generation dependents. Subsequently, those dependents will be picked one by one and wake up second-generation dependents in the dataflow graph one at a time. The process continues until all direct and indirect dependents have woken up and issued.

One can utilize the multiple hot instruction picked vector in a very different manner. The result of the Wakeup phase can be broadcast directly to the next Wakeup phase, completely cutting out the Pick logic from the critical loop. This implies that all first-generation dependents will still wake up one cycle after their producer, but all second-generation dependents will in turn wake up two cycles after the original producer and so on. Here one is effectively creating the transitive closure of all dependents by propagating a wave of readiness through the scheduler. Many more operations will wake up much sooner than they should with this scheme. In fact, it is possible that an operation that is dependent directly and indirectly on the same producer could wake up at the same time or even before its direct ancestor.

Meanwhile, the scheduler still tries to pick one operation every cycle from the set of ready operations. This Pick phase evaluates every cycle of the output of the Wakeup logic, but its output does not feed back to the Wakeup logic. This implies a breach of the Wakeup→Pick loop and the utilization of a Wakeup→Wakeup loop, providing the desired improvement in critical path latency.

Since wakeup may no longer be in age-priority order, it is possible that the scheduler could pick a dependent pair of instructions out of program order, violating von Neumann semantics. In order to prevent this, constraints are placed on the scheduler. The first constraint is that ready operations are picked in age-priority order. There are many ways to arrange this and no method requires adding any additional latency to the critical Wakeup phase.

The second constraint is that dependencies from one Wakeup phase are not propagated to a subsequent phase if the producer is a multi-cycle operation. In such a situation, it is possible that the dependent instruction of the multi-cycle operation could be issued on the very next cycle after the producer is issued. This would result in an apparent violation of causality since the consumer would be scheduled before the producer has finished operation and is ready to bypass its results. This constraint too can be implemented fairly easily with minimal additional latency to the Wakeup phase.

The third constraint is a more subtle one. There cannot be more than one execution pipe on any scheduler that implements this technique. Due to the transitive wakeup, a single-cycle producer and a single-cycle consumer might be concurrently ready and thus simultaneously be picked on two different pipes, which would again be an attempt to violate causality and program order. This constraint is trivial to arrange and also does not have any effect on Wakeup latency.

While various embodiments of the invention have been described above, it should be understood that they have been presented by way of example, and not limitation. It will be apparent to persons skilled in the relevant computer arts that various changes in form and detail can be made therein without departing from the scope of the invention. For example, in addition to using hardware (e.g., within or coupled to a Central Processing Unit (“CPU”), microprocessor, microcontroller, digital signal processor, processor core, System on chip (“SOC”), or any other device), implementations may also be embodied in software (e.g., computer readable code, program code, and/or instructions disposed in any form, such as source, object or machine language) disposed, for example, in a computer usable (e.g., readable) medium configured to store the software. Such software can enable, for example, the function, fabrication, modeling, simulation, description and/or testing of the apparatus and methods described herein. For example, this can be accomplished through the use of general programming languages (e.g., C, C++), hardware description languages (HDL) including Verilog HDL, VHDL, and so on, or other available programs. Such software can be disposed in any known non-transitory computer usable medium such as semiconductor, magnetic disk, or optical disc (e.g., CD-ROM, DVD-ROM, etc.). It is understood that a CPU, processor core, microcontroller, or other suitable electronic hardware element may be employed to enable functionality specified in software.

It is understood that the apparatus and method described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalents.

1. A processor, comprising:
a multiple stage pipeline including a scheduler with a wakeup block and select logic, wherein the wakeup block is configured to
wake, in a first cycle, all instructions dependent upon a first selected instruction to form a wake instruction set;
wake, in a second cycle, instructions dependent upon the wake instruction set to augment the wake instruction set;
and wherein the select logic selects instructions from the wake instruction set based upon program order.

2. The processor of claim 1 wherein for each additional cycle the wakeup block wakes instructions dependent upon the wake instruction set until all instructions are awake.

3. The processor of claim 1 wherein the wakeup block includes an instruction dependency vector characterizing instruction dependency.

4. The processor of claim 1 wherein the wakeup block includes an instruction picked vector characterizing picked instructions.

5. A non-transitory computer readable storage medium comprising executable instructions to define a processor configured with:
a multiple stage pipeline including a scheduler with a wakeup block and select logic, wherein the wakeup block is configured to
wake, in a first cycle, all instructions dependent upon a first selected instruction to form a wake instruction set;
wake, in a second cycle, instructions dependent upon the wake instruction set to augment the wake instruction set;
and wherein the select logic selects instructions from the wake instruction set based upon program order.

6. The non-transitory computer readable storage medium of claim 5 wherein for each additional cycle the wakeup block wakes instructions dependent upon the wake instruction set until all instructions are awake.

7. The non-transitory computer readable storage medium of claim 5 wherein the wakeup block includes an instruction dependency vector characterizing instruction dependency.

8. The non-transitory computer readable storage medium of claim 5 wherein the wakeup block includes an instruction picked vector characterizing picked instructions.

9. A method, comprising:
waking, in a first cycle, all instructions dependent upon a first selected instruction to form a wake instruction set;
waking, in a second cycle, instructions dependent upon the wake instruction set to augment the wake instruction set; and
selecting instructions from the wake instruction set based upon program order.

10. The method of claim 9 further comprising, for each additional cycle, waking instructions dependent upon the wake instruction set until all instructions are awake.

11. The method of claim 9 further comprising processing an instruction dependency vector characterizing instruction dependency.

12. The method of claim 9 further comprising processing an instruction picked vector characterizing picked instructions.
